(19) United States
(12) Patent Application Publication
(10) Pub. No.: US 2008/0137745 A1
(43) Pub. Date: Jun. 12, 2008

(54) Method and device for processing video data

(76) Inventors: Yu-Jen Lai, Taipei County (TW); Chih-Hung Lin, Tainan County (TW)

Correspondence Address: Akin Gump LLP - Silicon Valley, 3000 El Camino Real, Two Palo Alto Square, Suite 400, Palo Alto, CA, 94306, US

(21) Appl. No.: 11/638,016

(22) Filed: Dec. 12, 2006

(51) Int. Cl. H04N 7/26

(52) U.S. Cl. 375/240.16

(57) ABSTRACT

A device capable of video data processing includes a first unit capable of analyzing at least one motion vector of a macroblock to determine at least one sub-region in at least one reference, each of the at least one sub-region corresponding to one of the at least one motion vector, a second unit capable of storing pixel data of each of the at least one sub-region, a third unit capable of storing an address of each of the at least one reference block, and a fourth unit capable of retrieving from a memory device compensation data corresponding to the address of each of the at least one reference block.

### BACKGROUND OF THE INVENTION

The present invention relates generally to video data processing and more particularly, to a method and a device capable of reducing memory bandwidth requirements in processing video data.

Dynamic digital video data often require a large amount of storage and data transfer bandwidth. To reduce the amount of necessary storage and transfer bandwidth, video data processing systems may use various types of compression algorithms. International standards developed for video compression include MPEG-1 (Moving Pictures Expert Group), MPEG-2, MPEG-4, H.263 and H.264/AVC (“Advanced Video Coding”). These standardized compression schemes are based on a common core of compression techniques, i.e., predictive and/or interpolative inter-frame encoding, and may rely on several algorithm schemes such as motion compensation, discrete cosine transform (“DCT”), quantization of transform coefficients and variable length coding (“VLC”).

Motion compensation removes temporal redundancy between video frames. As an example of the MPEG standard, the motion compensation of an MPEG compressed bitstream includes an iterative process where Intra (I) frames, Predicted (P) frames and Bi-directional Interpolated (B) frames are reconstructed using a frame buffer or framestore memory. The framestore memory contains reconstructed image samples called reference frames from the input compressed bitstream. If an on-chip memory such as, for example, a static random access memory (“SRAM”) serves as a framestore memory for storing reference frames, the data access speed is desirable but the physical memory area may generally be unacceptable. As an example of the H.264 standard, to support 1080i (interlaced) and five reference frames in resolution, the memory size in an H.264 system may be as large as 10 MB (megabytes), which is not cost efficient in video data processing. Furthermore, since most of the data accesses within the chip are done through the on-chip SRAM, internal modules of the chip are required to access the on-chip SRAM in a more efficient manner and undesired accesses should be reduced to achieve an optimal bandwidth efficiency. However, such an SRAM, which supports efficient data access and improved bandwidth efficiency, may generally cost more. In most cases, an on-chip memory is insufficient to hold the video data for an entire reference frame without comprising the chip area. Thus, the framestore memory is typically an off-chip memory such as a synchronous DRAM (“SDRAM”) external to the chip.

In the case of an off-chip SDRAM to serve as the framestore memory, the cost efficiency may be improved but the bandwidth requirements are increased as compared to the case of the on-chip memory. Some additional overhead cycles, such as pre-charging and row or bank activation, are required prior to accessing data in the memory. Hence, when the current accessed row (or bank) is different from the previous one, some overhead cycles will occur. The overhead cycles will significantly slow down motion compensation of compressed video data. Furthermore, if the off-chip memory is common to chip modules over a system bus, these modules may contend for the memory bandwidth and the overhead cycles for internal bus access will be increased, which may further deteriorate the bandwidth efficiency.

It may be therefore desirable to have a method and a device capable of reducing memory bandwidth requirements in motion compensation.

### BRIEF SUMMARY OF THE INVENTION

Examples of the invention may provide a device capable of video data processing that comprises a first unit capable of analyzing at least one motion vector of a macroblock to determine at least one sub-region in at least one reference, each of the at least one sub-region corresponding to one of the at least one motion vector, a second unit capable of storing pixel data of each of the at least one sub-region, a third unit capable of storing an address of each of the at least one reference block, and a fourth unit capable of retrieving from a memory device compensation data corresponding to the address of each of the at least one reference block.

Examples of the invention may also provide a device capable of video data processing that comprises an analyzer unit capable of analyzing at least one motion vector of a macroblock to determine pixel data of each of at least one sub-region in at least one reference and an address of each of the at least one reference block, each of the at least one sub-region corresponding to one of the at least one motion vector, an address pool unit capable of storing the address of each of the at least one reference block, a memory access unit capable of sending a request to a memory controller for compensation data corresponding to one of the address of each of the at least one reference block, and a pixel data unit capable of storing pixel data of each of the at least one sub-region and providing pixel data corresponding to the compensation data.

Some examples of the invention may also provide a method of video data processing that comprises providing a macroblock including at least one motion vector, dividing the macroblock into at least one sub-block each corresponding to one of the at least one motion vector, analyzing the at least one motion vector to determine at least one sub-region in at least one reference block, each of the at least one sub-region corresponding to one of the at least one motion vector, determining pixel data of each of the at least one sub-region, determining an address of each of the at least one reference block, retrieving compensation data corresponding to one of the address of each of the at least one reference block, and retrieving pixel data corresponding to the compensation data.

Examples of the invention may also provide a method of video data processing that comprises providing at least one macroblock each including at least one motion vector, dividing each of the at least one macroblock into at least one sub-block each corresponding to one of the at least one motion vector, analyzing the at least one motion vector for each of the at least one macroblock to determine at least one sub-region in at least one reference block, each of the at least one sub-region corresponding to one of the at least one motion vector, determining pixel data of each of the at least one sub-region, determining an address of each of the at least one reference block, retrieving compensation data corresponding to one of the address of each of the at least one reference block, and retrieving pixel data corresponding to the compensation data.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings examples consistent with the invention. It should be understood, however, that the invention is not limited to the precise arrangements and instrumentalities shown.

In the drawings:

FIG. 1A is a schematic diagram illustrating a method of data processing consistent with one example of the present invention;

FIGS. 1B to 1E are schematic amplified views of the reference frames illustrated in FIG. 1A;

FIG. 2 is a schematic diagram illustrating a method of data processing consistent with another example of the present invention;

FIG. 3 is a schematic diagram of the data structure of a memory consistent with an example of the present invention;

FIG. 4A is a schematic diagram of the data structure of a memory consistent with another example of the present invention;

FIG. 4B is a schematic diagram of the data structure of a conventional memory;

FIG. 5 is a block diagram of a module capable of reducing memory bandwidth requirements consistent with an example of the present invention;

FIG. 6 is a flow diagram illustrating a method of motion compensation consistent with an example of the present invention; and

FIG. 7 is a diagram illustrating experimental results of a method consistent with the present invention.

### DETAILED DESCRIPTION OF THE INVENTION

Reference will now be made in detail to the present embodiments of the invention, examples of which are illustrated in the accompanying drawings. Wherever possible, the same reference numbers will be used throughout the drawings to refer to the same or like portions.

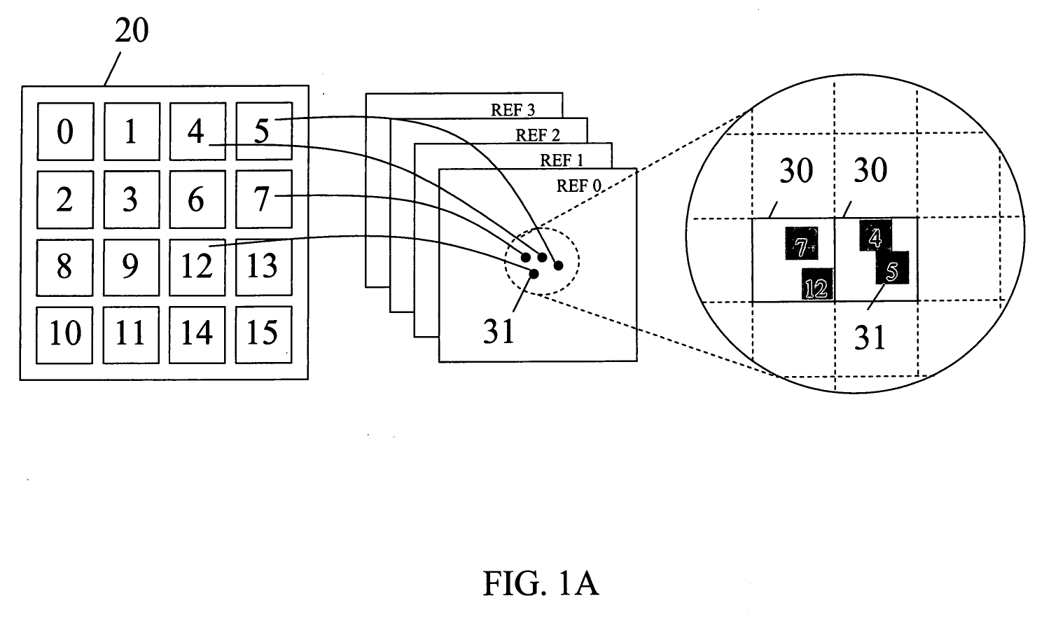

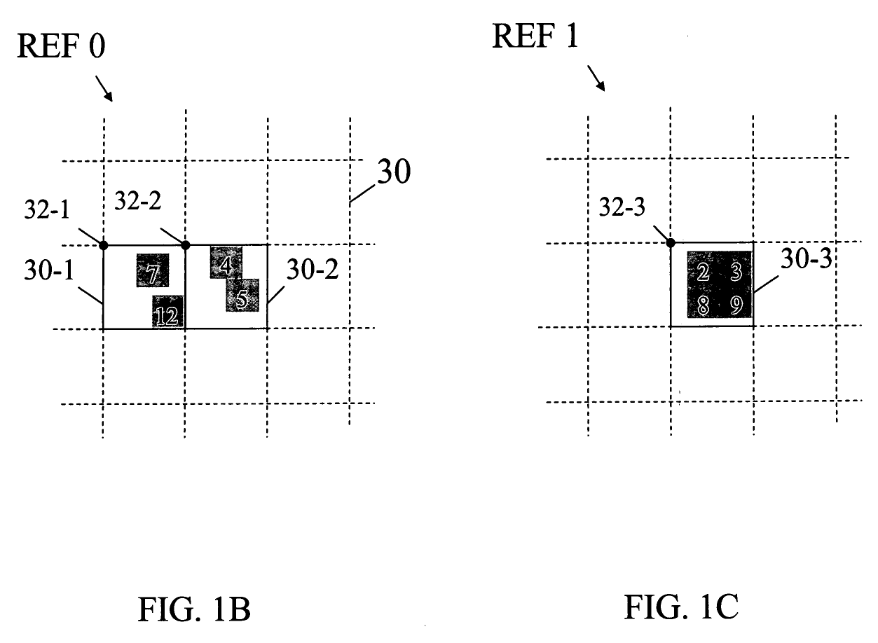

FIG. 1A is a schematic diagram illustrating a method of data processing consistent with one example of the present invention. Referring to FIG. 1A, a macroblock 20 to be reconstructed is provided. The macroblock 20, including at least one motion vector, is divided into at least one sub-block labeled 0 to 15, each including a respective one of the at least one motion vector. In the present example, the macroblock 20 includes a 16×16 pixel square and each of the at least one sub-block 0 to 15 includes a 4×4 pixel square. In other examples, the macroblock 20 includes one of a 16×16, 16×8, 8×16, 8×8, 8×4, 4×8 and 4×4 pixel square. Furthermore, each of the at least one sub-block 0 to 15, which may be equal in size to the macroblock 20, also includes one of a 16×16, 16×8, 8×16, 8×8, 8×4, 4×8 and 4×4 pixel square. The macroblock 20 and the at least one motion vector are generated by, for example, an MPEG encoder, which has been well known to skilled persons in the art and is not discussed. Each of the at least one motion vector includes a pointer from one corresponding sub-block 0 to 15 to a sub-region 31 in one of reference frames labeled REF 0 to REF 3. Compensation data are accessible from the sub-region 31. In the present example, four reference frames REF 0 to REF 3, which have been stored in an off-chip memory, are used to reconstruct the macroblock 20. The sub-regions 31 in the reference frames REF 0 to REF 3 are analyzed. As illustrated in an amplified view in FIG. 1A, the motion vectors of the sub-blocks 4, 5, 7 and 12 point to corresponding sub-regions labeled 4, 5, 7 and 12 in the reference frame REF 0. The sub-regions 7 and 12 are located in a reference block 30 while the sub-regions 4 and 5 are located in another reference block 30, which will be further described below.

FIGS. 1B to 1E are schematic amplified views of the reference frames REF 0 to REF 3 illustrated in FIG. 1A. Referring to FIG. 1B, the reference frame REF 0, like the other reference frames REF 1 to REF 3, includes an array of reference blocks 30 formed in rows and columns. In the reference frame REF 0, the sub-regions 7 and 12 are located in a reference block 30-1 of the reference blocks 30 with an address 32-1, which corresponds to the beginning of the reference block 30-1. Information on the locations of the sub-regions 7 and 12 per pixel is recorded and may be retrieved for motion compensation. The size of each of the reference blocks 30 is a trade-off between data utility and overhead. Specifically, a large reference block may suffer from low data utility, while a small reference block may disadvantageously result in high overhead. In one example according to the present invention, the reference blocks 30 have a size sufficient to support a burst access. That is, compensation data in the sub-regions 7 and 12 are accessible from the reference block 30-1 at the address 32-1 in one burst read operation. The reference block size is, for example, equal to a macroblock size, i.e., 16×16 pixel square. In another example, the reference block size is several times of a macroblock size, depending on user's need.

Furthermore, in the reference frame REF 0, the sub-regions 4 and 5 are located in another reference block 30-2 of the reference blocks 30 with an address 32-2. Information on the locations of the sub-regions 4 and 5 per pixel is recorded and may be retrieved for motion compensation. Likewise, compensation data in the sub-regions 4 and 5 are accessible from the reference block 30-2 at the address 32-2 in one burst access. Nevertheless, since the reference block 30-1 is contiguous with the reference block 30-2, compensations data in the sub-regions 7, 12, 4 and 5 are accessible from these reference blocks 30-1 and 30-2 at the address 32-1 in one burst access, which advantageously results in the reduction of burst overhead and in turn the reduction of memory bandwidth requirements. The present invention makes use of the property of contiguity in motion compensation, wherein compensation data required for motion compensation generally do not scatter around and instead may tend to accumulate and exhibit good contiguity. In the present example, two reference blocks 30-1 and 30-2 of compensation data are accessible at one address 32-1 in one burst. In other examples where three or more reference blocks are contiguous with each other in one row, compensation data in these contiguous reference blocks are accessible at one address in one burst. However, skilled persons in the art will understand that the maximum number of contiguous reference blocks accessible in one burst may depend on whether a memory controller in charge of the off-chip memory can support.

Referring to FIG. 1C, in the reference frame REF 1, sub-regions 2, 3, 8 and 9 are located within a reference block 30-3 with an address 32-3. Information on the locations of the sub-regions 2, 3, 8 and 9 per pixel is recorded and may be retrieved for motion compensation. Likewise, compensation data in the sub-regions 2, 3, 8 and 9 are accessible from the reference block 30-3 at the address 32-3 in one burst access.

Referring to FIG. 1D, in the reference frame REF 2, cross-block sub-regions 1, 6, 13 and 14 may appear as often as in-block sub-regions 0, 10, 11 and 15. Specifically, the sub-region 1 overlaps reference blocks 30-4 and 30-5, the sub-region 6 overlaps reference blocks 30-4 and 30-6, the sub-region 13 overlaps reference blocks 30-4, 30-5, 30-6 and 30-7, and the sub-region 14 overlaps reference blocks 30-7 and 30-8. Information on the locations of the sub-regions 0, 1, 6, 10, 11, 13, 14 and 15 in the reference blocks 30-4 to 30-9 per pixel is recorded. Since the reference blocks 30-4 and 30-5 are contiguous in a row, compensation data within the reference blocks 30-4 and 30-5, including those in the entire sub-regions 0 and 1 and portions of the sub-regions 6 and 13, are accessible at an address 32-4 in one burst. Similarly, since the reference blocks 30-6 and 30-7 are contiguous in a row, compensation data within the reference blocks 30-6 and 30-7, including those in the remaining portions of the sub-regions 6 and 13, the entire sub-regions 10 and 11 and a portion of the sub-region 14, are accessible at an address 32-6 in one burst. Moreover, since the reference blocks 30-8 and 30-9 are contiguous in a row, compensation data within the reference blocks 30-8 and 30-9, including those in the remaining portion of the sub-region 14 and the entire sub-region 15, are accessible at an address 32-8 in one burst.

Referring to FIG. 1E, no sub-regions are found in the reference frame REF 3. All of the sub-regions 0 to 15 corresponding to the sub-blocks 0 to 15 are analyzed. In the present example illustrated with respect to FIGS. 1A to 1E, only one macroblock 20 is analyzed. In other examples, more than one macroblock is analyzed, which may advantageously enhance the contiguity of sub-regions in reference blocks, and in turn help reduce the burst overhead.

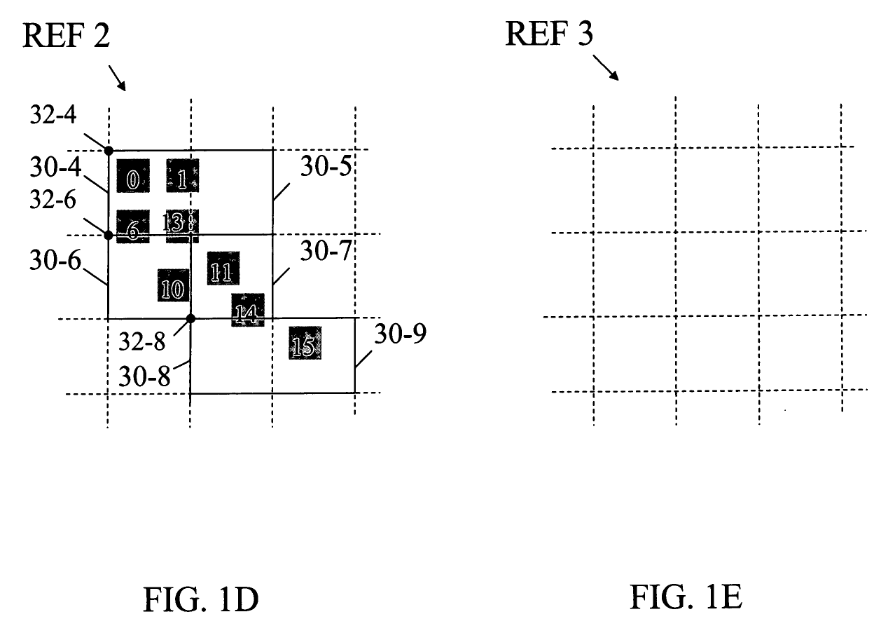

FIG. 2 is a schematic diagram illustrating a method of data processing consistent with another example of the present invention. Referring to FIG. 2, a macroblock 40 to be reconstructed is provided. The macroblock 40, including at least one motion vector, is divided into at least one sub-block labeled 0 to 5, each including a respective one of the at least one motion vector. In the present example, the macroblock 40 includes a 16×16 pixel square, each of the sub-blocks 0 to 3 includes a 4×4 pixel square, and the sub-blocks 4 and 5 include an 8×8 and a 16×8 pixel squares, respectively. Each of the at least one motion vector includes a pointer from one corresponding sub-block 0 to 5 to a corresponding sub-region in one of reference frames labeled REF 0 to REF 3. As illustrated in an amplified view in FIG. 2, the motion vectors of the sub-blocks 1, 4 and 5 point to corresponding sub-regions labeled 1, 4 and 5 in the reference frame REF 0. The size of a sub-region is approximately proportional to that of a corresponding sub-block so that the larger the sub-block, the larger the corresponding sub-region. Hence in the reference frame REF 0, the sub-region 5 is greater in size than the sub-region 1 because the sub-block 5 is greater in size than the sub-block 1.

Furthermore, in the reference frame REF 0, the sub-region 4 overlaps reference blocks 50-1 and 50-2, and the sub-region 5 overlaps reference blocks 50-3, 50-4, 50-5 and 50-6. Since the reference blocks 50-1 and 50-2 are contiguous in a row, compensation data within the reference blocks 50-1 and 50-2, including those in the sub-regions 1 and 4, are accessible at an address 52-1 in one burst. Similarly, since the reference blocks 50-3 and 50-4 are contiguous in a row, compensation data within the reference blocks 50-3 and 50-4, including those in portions of the sub-region 5, are accessible at an address 52-3 in one burst. Moreover, since the reference blocks 50-5 and 50-6 are contiguous in a row, compensation data within the reference blocks 50-5 and 50-6, including those in the remaining portions of the sub-region 5, are accessible at an address 52-5 in another burst.

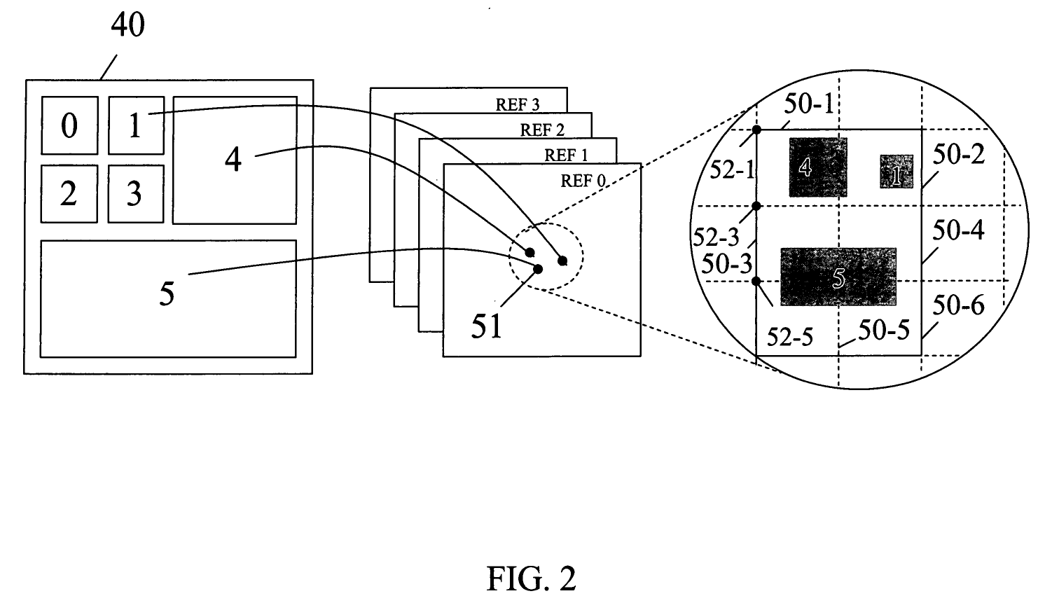

FIG. 3 is a schematic diagram of the data structure of a memory 60 consistent with an example of the present invention. Referring to FIG. 3, the memory 60 includes a plurality of memory banks for storing compensation data. For the purpose of simplicity, only banks labeled 0 and N are illustrated. Each of the memory banks, for example, the bank 0, includes an array of memory cells 61 formed in rows and columns. Each of the memory cells 61 has a size equal to that of a reference block of a reference frame illustrated in FIG. 1B, 1C or 1D so that the data in the each memory cell 61 is able to be read in one burst access. Furthermore, each of the memory banks may have a sacrifice margin 62 where data are not stored. The sacrifice margin 62 prevents a cross-bank data read operation and therefore eliminates the need to activate a bank change, which reduces the burst overhead.

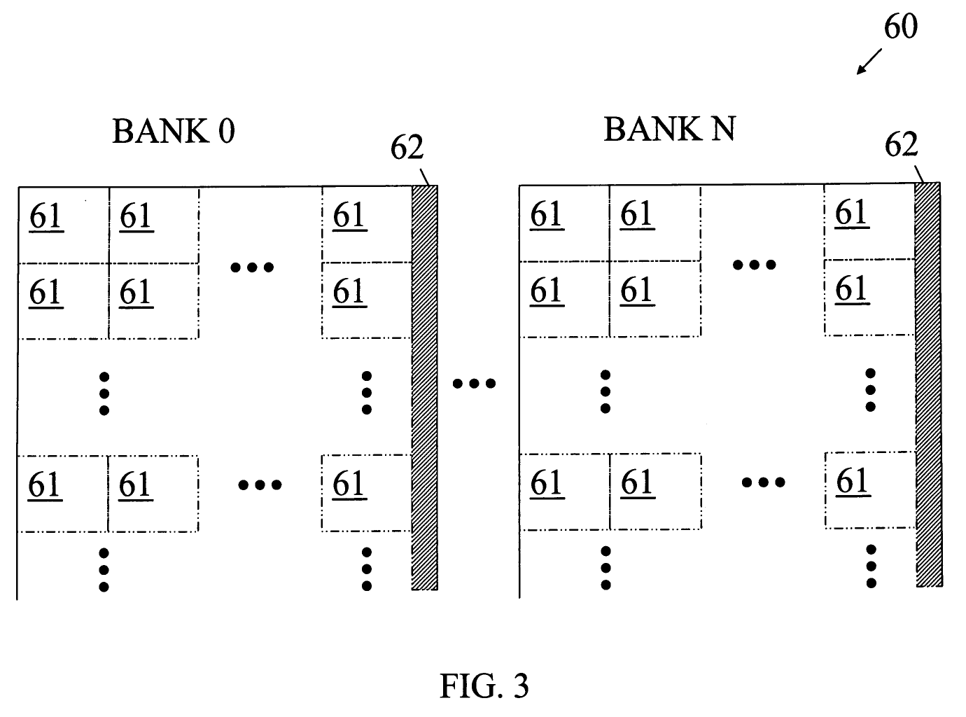

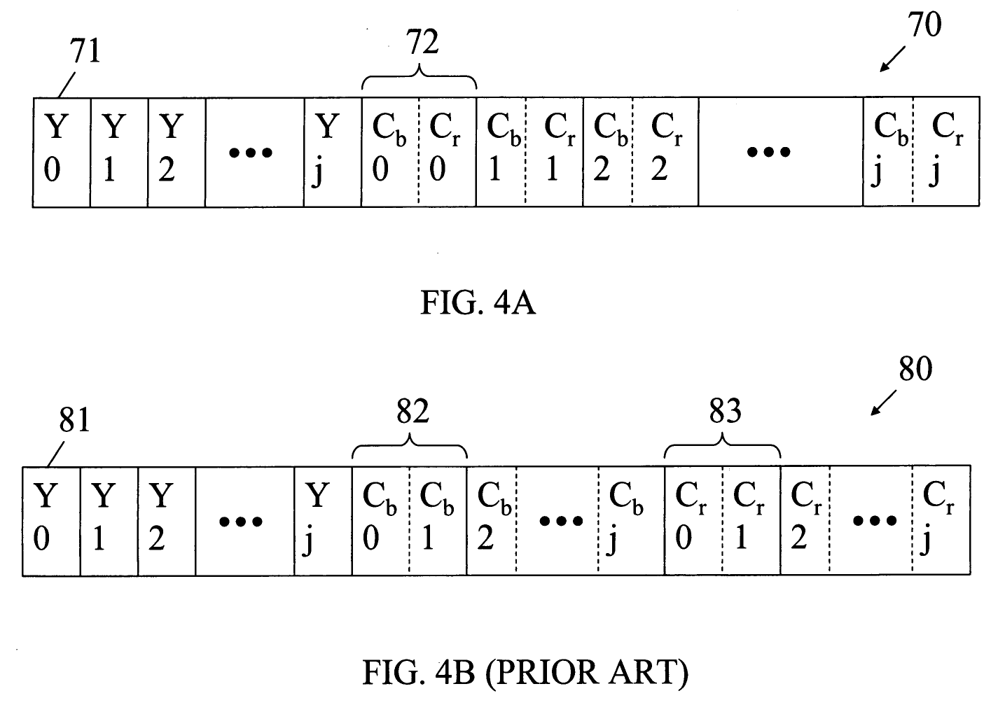

FIG. 4A is a schematic diagram of the data structure of a memory 70 consistent with another example of the present invention. In image data processing, many color spaces are used in various applications. In a YCbCr color space, the Y, Cb and Cr are the color components of input image pixels, where the Y component represents luminance (intensity or picture brightness), the Cb component represents the scaled difference between the blue value and the luminance (Y), and the Cr component represents the scaled difference between the red value and the luminance (Y). Since digitized YCbCr components occupy less bandwidth when compared to digitized RGB (Red-Green-Blue) components, compressed video data may generally represent colors in the YCbCr space. The chrominance components Cb and Cr are half of the size of the luminance component Y and are stored after the luminance components Y in a memory.

Referring to FIG. 4A, each of the luminance signals Y0 to Yj are stored in one of memory cells 71 of the memory 70, wherein each of the memory cells has a size equal to that of a reference block of a reference frame illustrated in FIG. 1B, 1C or 1D. Furthermore, every two chrominance signals Cb and Cr for a reference block are stored in another memory cell 72 of the memory 70. For example, given the color information for a reference block including the signals Y0, Cb0 and Cr0, the chrominance signals Cb0 and Cr0 are stored in the same memory cell 72 to reduce the burst overhead.

FIG. 4B is a schematic diagram of the data structure of a conventional memory 80. Referring to FIG. 4B, the luminance signals Y0 to Yj, the first chrominance signals Cb and the second chrominance signals Cr are stored in different cell blocks 81, 82 and 83, respectively. To retrieve the color information for a given reference block including the signals Y0, Cb0 and Cr0, an additional burst access is required for the data structure of the conventional memory 80 as compared to that of the memory 70 illustrated in FIG. 4A.

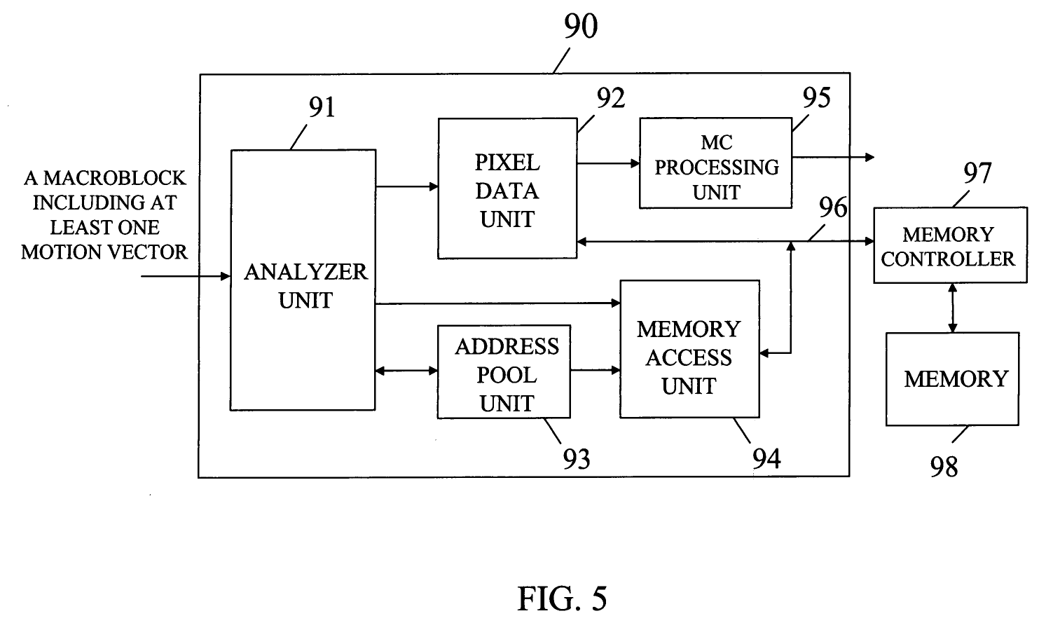

FIG. 5 is a block diagram of a module 90 capable of reducing memory bandwidth requirements consistent with an example of the present invention. Referring to FIG. 5, the module 90 includes an analyzer unit 91, a pixel data unit 92, an address pool unit 93, a memory access unit 94 and a motion compensation processing unit 95. The analyzer unit 91 analyzes at least one motion vector in an incoming macroblock, which includes at least one sub-block and each of the at least one sub-block corresponds to one of the at least one motion vector, and determines at least one sub-region corresponding to the at least one motion vector in at least one reference block of a reference frame stored in a memory. Each of the at least one reference block includes at least a portion of one of the at least one sub-region. Furthermore, the analyzer unit 91 determines an address of each of the at least one reference block and checks whether the address has been stored in the address pool unit 93. If not, the address is stored in the address pool unit 93. If confirmative, the address is filtered and not stored. The analyzer 91 also determines the pixel data such as pixel location or address of the pixels of each of the at least one sub-region, and stores the pixel data in the pixel data unit 92. The address of the reference block and the pixel data facilitate the retrieval of corresponding compensation data stored in a reference frame, as will be further discussed below.

After all of the at least one motion vector of the incoming macroblock are analyzed, the memory access unit 94 transmits a request over a system bus 96 to a memory controller 97 in response to one of the addresses of the at least one reference block stored in sequence in the address pool unit 93. The memory controller 97 retrieves compensation data corresponding to the one address in a memory 98 and sends the compensation data over the system bus 96 to the pixel data unit 92. The pixel data unit 92, including at least one monitors corresponding to the at least one sub-region for monitoring the system bus 96, stores the compensation data sent over the system bus 96. Once the compensation data for one of the at least one sub-region are retrieved and stored, the pixel data unit 92 provides the compensation data associated with the corresponding pixel data to the motion compensation processing unit 95 for motion compensation. In response to the compensation data from the memory controller 97, the address pool unit 93 transmits a request over the system bus 96 for compensation data corresponding to the next one of the addresses of the at least one reference blocks in the sequence. When the compensation data for all of the at least one sub-block are retrieved and sent to the motion compensation processing unit with their corresponding pixel data, the motion compensation process for the macroblock is completed.

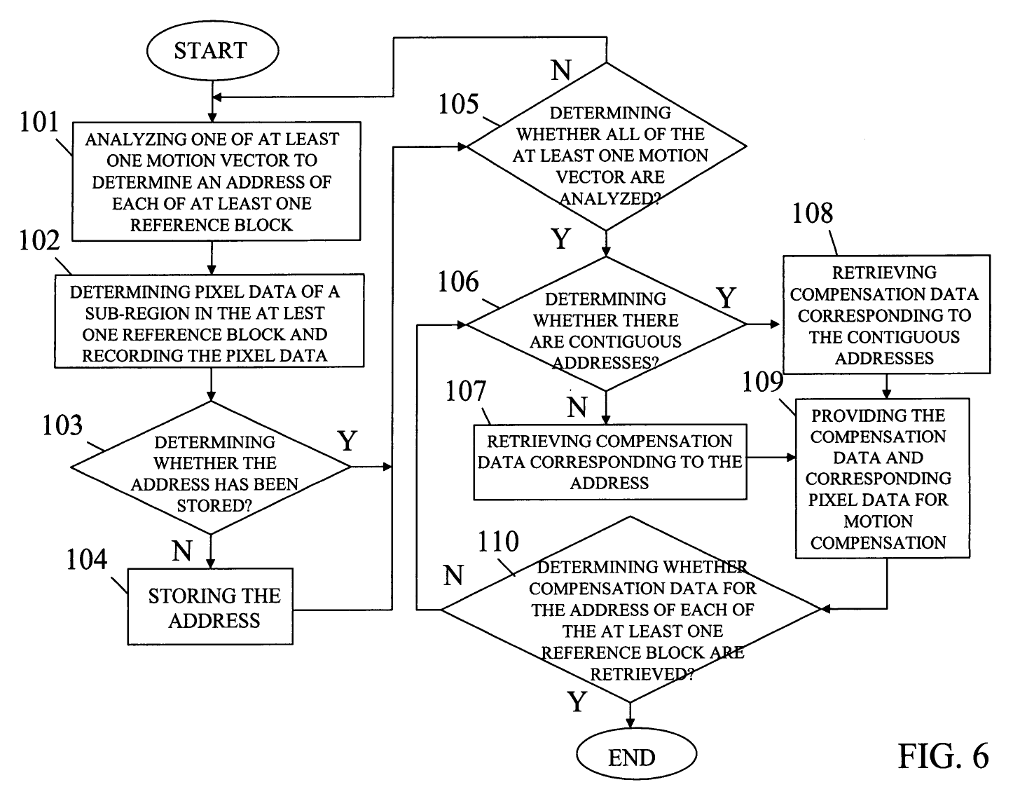

FIG. 6 is a flow diagram illustrating a method of motion compensation consistent with an example of the present invention. Referring to FIG. 6, at step 101, at least one macroblock each including at least one motion vector is provided. Each of the at least one macroblock is divided into at least one sub-block in accordance with the at least one motion vector such that each of the at least one sub-block corresponds to one of the at least one motion vector. Each of the at least one motion vector is analyzed to determine a sub-region in at least one reference block of a reference frame stored in a memory. An address of each of the at least one reference block is determined. Next, at step 102, pixel data of each pixels of the sub-region are determined and recorded. It is determined at step 103 whether the address of the at least one reference block is redundant. If confirmative, the address is not stored. If not, the address is stored in an address pool unit at step 104. Next, at step 105, it is determined whether all of the at least one motion vector are analyzed. If not, the motion vector corresponding to another sub-block of the macroblock is analyzed at step 101. If confirmative, at step 106, it is determined whether there are addresses in the address pool unit corresponding to contiguous reference blocks in a row. If not, at step 107, compensation data corresponding to an address stored in the address pool unit are retrieved from a memory in response to a request sent from a memory access unit to a memory controller in charge of the memory. If confirmative, compensation data corresponding to the addresses are retrieved in one burst access at step 108. Next, at step 109, to perform motion compensation for the current sub-block, pixel data corresponding to the compensation data are provided together with the compensation data to a motion compensation processing unit. At step 110, it is determined whether compensation data corresponding to the address of each of the at least one reference block are retrieved. If not, another address request is made at the memory access unit in order to retrieve compensation data corresponding to the address.

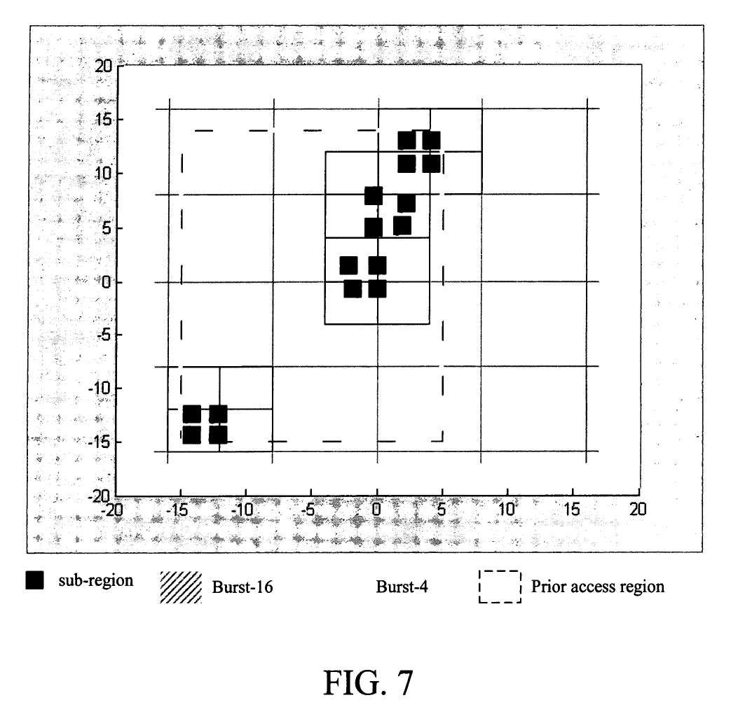

FIG. 7 is a diagram illustrating experimental results of a method consistent with the present invention. Referring to FIG. 7, sixteen sub-blocks (represented in dark blocks), which correspond to sixteen motion vectors (not shown), need motion compensation. According to a method consistent with the present invention, four burst-16 accesses (represented in oblique lines) and three burst-4 accesses (represented in netted lines) are required to perform motion compensation for the sixteen sub-blocks, wherein a burst-m access refers to scan m pixels in one burst, m being an integer. Given an indispensable overhead of eleven (11) cycles for each burst access, the overhead cycles required for the method of the present invention are calculated below.

Burst-16×4+Burst-4×3=(11+16)×4+(11+4)×3=153 cycles

By comparison, in a prior art method disclosed in U.S. Pat. No. 6,996,178 to Zhang et. al., entitled “Look Ahead Motion Compensation”, to perform motion compensation for the sixteen sub-blocks illustrated in FIG. 7, thirty Burst-6 accesses (altogether represented in a dashed-line block) are required. The overhead cycles required for the prior art method are calculated below.

Burst-6×30=(11+6)×30=510 cycles

The comparison reveals that the method according to the present invention may achieve significant improvement in the reduction of bandwidth requirements.

It will be appreciated by those skilled in the art that changes could be made to one or more of the examples described above without departing from the broad inventive concept thereof. It is understood, therefore, that this invention is not limited to the particular examples disclosed, but it is intended to cover modifications within the scope of the present invention as defined by the appended claims.

Further, in describing certain illustrative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

We claim:

1. A device capable of video data processing, comprising:
a first unit capable of analyzing at least one motion vector of a macroblock to determine at least one sub-region in at least one reference, each of the at least one sub-region corresponding to one of the at least one motion vector;
a second unit capable of storing pixel data of each of the at least one sub-region;
a third unit capable of storing an address of each of the at least one reference block; and
a fourth unit capable of retrieving from a memory device compensation data corresponding to the address of each of the at least one reference block.

2. The device of claim 1, wherein the first unit determines the pixel data of each of the at least one sub-region and stores the pixel data in the second unit.

3. The device of claim 1, wherein the first unit determines the address of each of the reference block and stores the address in the third unit if the address has not been stored in the third unit.

4. The device of claim 1, wherein the fourth unit generates a request to a memory controller in charge of the memory in response to an address stored in the third unit.

5. The device of claim 4, wherein the fourth unit retrieves compensation data corresponding to the address stored in the third unit through the memory controller over a system bus.

6. The device of claim 5, wherein the second unit provides pixel data corresponding to the compensation data in response to the address stored in the third unit.

7. The device of claim 1, wherein data contained in each of the at least one reference block are capable of being retrieved in a burst access.

8. The device of claim 1, wherein the memory device includes a plurality of banks each comprising an array of memory cells formed in rows and columns, and data contained in each of the memory cells are capable of being retrieved in a burst access.

9. The device of claim 1, wherein the memory device includes a plurality of banks each comprising an array of memory cells formed in rows and columns, and each of the plurality of banks includes a sacrifice margin.

10. The device of claim 8, wherein color information of the macroblock is represented in a YCbCr color space, and wherein a luminance signal Y corresponding to one of the at least one reference block is stored in one of the memory cells and chrominance signals Cb and Cr corresponding to the same one reference block are stored in another one of the memory cells.

11. A device capable of video data processing, comprising:
an analyzer unit capable of analyzing at least one motion vector of a macroblock to determine pixel data of each of at least one sub-region in at least one reference and an address of each of the at least one reference block, each of the at least one sub-region corresponding to one of the at least one motion vector;
an address pool unit capable of storing the address of each of the at least one reference block;
a memory access unit capable of sending a request to a memory controller for compensation data corresponding to one of the address of each of the at least one reference block; and
a pixel data unit capable of storing pixel data of each of the at least one sub-region and providing pixel data corresponding to the compensation data.

12. The device of claim 11, wherein the memory access unit retrieves the compensation data corresponding to one of the address of each of the at least one reference block from a memory device through the memory controller.

13. The device of claim 11, wherein data contained in each of the at least one reference block are capable of being retrieved in a burst access.

14. The device of claim 12, wherein the memory device includes a plurality of banks each comprising an array of memory cells formed in rows and columns, and data contained in each of the memory cells are capable of being retrieved in a burst access.

15. The device of claim 14, wherein the memory device includes a plurality of banks each comprising an array of memory cells formed in rows and columns, and each of the plurality of banks includes a sacrifice margin.

16. The device of claim 14, wherein color information of the macroblock is represented in a YCbCr color space, and wherein a luminance signal Y corresponding to one of the at least one reference block is stored in one of the memory cells and chrominance signals Cb and Cr corresponding to the same one reference block are stored in another one of the memory cells.

17. A method of video data processing, comprising:
providing a macroblock including at least one motion vector;
dividing the macroblock into at least one sub-block each corresponding to one of the at least one motion vector;
analyzing the at least one motion vector to determine at least one sub-region in at least one reference block, each of the at least one sub-region corresponding to one of the at least one motion vector;
determining pixel data of each of the at least one sub-region;
determining an address of each of the at least one reference block;
retrieving compensation data corresponding to one of the address of each of the at least one reference block; and
retrieving pixel data corresponding to the compensation data.

18. The method of claim 17, further comprising:
determining whether one of the address of each of the at least one reference block has been stored; and
storing the one of the address of each of the at least one reference block.

19. The method of claim 17, further comprising:
requesting a memory controller in charge of a memory device in response to one of the address of each of the at least one reference block.

20. The method of claim 17, further comprising:
providing the compensation data and pixel data corresponding to the compensation data for motion compensation.

21. The method of claim 17, further comprising:
retrieving data contained in each of the at least one reference block in a burst access.

22. The method of claim 19, further comprising:
retrieving contained in each of memory cells of the memory device in a burst access.

23. The method of claim 19, further comprising:
representing color information of the macroblock in a YCbCr color space;
storing a luminance signal Y corresponding to one of the at least one reference block in one of memory cells of the memory device; and
storing chrominance signals Cb and Cr corresponding to the same one reference block in another one of the memory cells.

24. The method of claim 19, further comprising:
determining whether reference blocks are contiguously stored in a row of the memory device; and
retrieving data contained in the reference blocks in a burst access.

25. A method of video data processing, comprising:
providing at least one macroblock each including at least one motion vector;
dividing each of the at least one macroblock into at least one sub-block each corresponding to one of the at least one motion vector;
analyzing the at least one motion vector for each of the at least one macroblock to determine at least one sub-region in at least one reference block, each of the at least one sub-region corresponding to one of the at least one motion vector;
determining pixel data of each of the at least one sub-region;
determining an address of each of the at least one reference block;
retrieving compensation data corresponding to one of the address of each of the at least one reference block; and
retrieving pixel data corresponding to the compensation data.

26. The method of claim 25, further comprising:
requesting a memory controller in charge of a memory device in response to one of the address of each of the at least one reference block.

27. The method of claim 25, further comprising:
providing the compensation data and pixel data corresponding to the compensation data for motion compensation.

28. The method of claim 26, further comprising:
retrieving contained in each of memory cells of the memory device in a burst access.

29. The method of claim 26, further comprising:
representing color information of the macroblock in a YCbCr color space;
storing a luminance signal Y corresponding to one of the at least one reference block in one of memory cells of the memory device; and
storing chrominance signals Cb and Cr corresponding to the same one reference block in another one of the memory cells.

30. The method of claim 26, further comprising:
determining whether reference blocks are contiguously stored in a row of the memory device; and
retrieving data contained in the reference blocks in a burst access.
